(19) United States
(12) Patent Application Publication
(10) Pub. No.: US 2006/0176643 A1
(43) Pub. Date: Aug. 10, 2006

(54) Apparatus which integrates a time control into a detachable power cord

(76) Inventor: Rick Alan Pecore, Manitowoc, WI (US)

Correspondence Address: Rick A. Pecore, 3301 Samuel Road, Manitowoc, WI, 54220, US

(21) Appl. No.: 11/053,393

(22) Filed: Feb. 8, 2005

(51) Int. Cl. H01T 23/00

(52) U.S. Cl. 361/230

(57) ABSTRACT

An apparatus which integrates a time control into a detachable power cord. The invention includes an integral power input cord having a power input connector capable of being connected directly to a power source, an integral power output cord having a power output connector capable of being connected directly to an electrical load, a switch for enabling or disabling power to the power output cord, a load status detector for determining whether the electrical load is ON or OFF, a timekeeping mechanism for tracking time-of-day, programmable time limits for restricting usage of the electrical load, non-volatile storage for critical data, secure access to time and program data, and a numeric display and pushbuttons for system interaction. The invention provides inherent security because the timer is integral to the power cord, thus the timer cannot be bypassed. Further, no mechanical locking mechanisms are required to capture a secondary power cord.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of time controls, and more specifically to an apparatus which integrates a time control into a detachable power cord.

The invention has its basis in two observations. First, many electrical and electronic products are now designed with a detachable power cord. This approach has several advantages. For the manufacturer, this provides the ability to service multiple types of power connectors by altering only the inexpensive power cord's configuration, while the more expensive base product can remain the same for all applications. For the consumer, if the power cord becomes damaged, it can be easily and safely replaced at little cost and without affecting the base unit.

The second observation is that it is often desirable to limit the operation of an electrical or electronic device by setting time restrictions. A prime example of this is video games. These games are generally very appealing to children but can lead to addictive behavior, thus it is of interest to limit their use. Other examples of products that could benefit from such limited operation include computers, radios, and televisions.

The invention addresses the latter need by taking advantage of the former condition. That is, the invention integrates a time control directly into a detachable power cord.

The present invention relies on a time control to limit the usage of an electrical or electronic load. By itself, this concept is described by several existing U.S. patents. Probably the simplest of these is U.S. Pat. No. 3,833,779 to Leone, “Television Timer to Regulate Television Viewing Time.” This design places a time control within a locked enclosure. Within this same locked enclosure is a power outlet to which the load's existing power cord is connected, thus providing security to ensure the time control is not bypassed. A variation of this design is seen in U.S. Pat. No. 6,519,208 to DeVries where the enclosure is attached to a wall outlet.

This basic concept of applying time restrictions to limit load usage, whereby the controlling device includes a general-purpose power outlet for connection to the load's existing power cord, is expanded upon in other prior art. U.S. Pat. No. 4,588,901 to Maclay et al. and U.S. Pat. No. 5,331,353 to Levenson both apply programmable time limits to load usage. These designs determine load status (ON or OFF) by monitoring load current. When the load is found to be ON, the day's time allotment is decremented until it reaches zero, at which time the load is disabled by opening a switch in series with the power outlet. U.S. Pat. No. 5,231,310 to Oh describes a similar system, with particular attention lent to the mechanism which secures the load's existing power cord to the controlled power outlet. Such a time-limiting, load-current monitoring power control scheme is not unique, nor is it unlike the timing and control operation presented in the invention. However, these existing designs and others like them provide only general power inputs and outputs; they are not designed to completely replace an existing power cord, and thus require a mechanical locking mechanism to effectively prevent others from bypassing the control features.

This need for a physical locking mechanism to capture an existing power cord is expanded upon by U.S. Pat. 5,283,475 to Berger, which places an emphasis on mechanical locking features and uses time-of-day as the basis for control, whereby the design only enables its power output during a programmed time and is not cognizant of whether the load is ON or OFF.

There are a multitude of other patents that address the concept of applying a time-based restriction on an electrical load. U.S. Pat. No. 4,348,696 to Beier illustrates a television viewing control device which requires each user to enter a password to energize the power output, at which time that user's time allotment is debited until no time remains. As such, the control must be made aware, through password entry, of when operation starts and ends. The password entry also provides system security, along with the ubiquitous mechanical interlock for the load's existing power cord. A variation of this concept is described in U.S. Pat. No. 5,046,157 to Smith et al. wherein a separate “user card” is required for system access and control, whereby said “user card” is presented to the device to enable power and begin timing. Still, without a mechanical interlock for the load's existing power cord, this system will not be effective. We also see U.S. Pat. No. 5,051,837 to McJunkin, presented as a home entertainment equipment control apparatus. It is a more refined design, again offering time-based control of a device having its existing power cord connected to the controlled power outlet, and again requiring a mechanical interlock for security.

Other prior art of interest includes U.S. Pat. No. 6,011,328 to Smith. This patent does not provide for any time-based control, but instead offers secure access for enabling power. This design approach again requires the use of a mechanical locking mechanism to ensure the load's existing power cord remains secure. U.S. Pat. No. 5,731,763 to Herweck et al. also presents an access controller that interfaces with an existing power cord and requires a mechanical interlock in order to provide security. As with Smith, this patent addresses access control only and does not introduce any timing mechanisms. U.S. Pat. No. 5,731,763 to Herweck et al. and U.S. Pat. No. 6,777,828 to Rothstein describe similar systems which introduce remote control.

All the previously mentioned designs operate with AC power in and AC power out. We also see U.S. Pat. No. 5,795,229 to Johnson which operates with AC power in but having a plurality of DC power outputs. This system is primarily for power distribution. It offers a master control switch, but does not provide any time-based control or load status monitoring, such as current sensing.

All of the above employ a control means which serves to interrupt power to an external electrical or electronic device. Other patents exist which present a similar time-based load restriction, but function by interrupting a low-level signal rather than a power source. Examples of this can be seen in U.S. Pat. No. 5,060,079 to Rufus-Isaacs, U.S. Pat. No. 5,168,372 to Sweetser, U.S. Pat. No. 5,231,661 to Harnum et al., U.S. Pat. No. 5,382,983 to Kwoh et al., U.S. Pat. No. 5,548,345 to Brian et al., U.S. Pat. No. 5,917,256 to Broadbent II, and U.S. Pat. No. 6,025,869 to Stas et al. These designs all provide a different design than the invention, as they interrupt a low-level signal (such as a video feed) rather than a power source. We also see U.S. Pat. No. 5,964,661 to Dodge which includes embodiments that switch both signal and power lines. It is further noted that Stas also describes a power interruption means similar to that described by Levenson and Maclay and Oh, though this feature is not claimed by Stas.

The primary deficiency in all this prior technology is the need to interface with an existing power cord. This presents several disadvantages, the most obvious of which is security. In order to make these existing devices tamper-proof, they must provide a means to physically secure the load's existing power cord to the control. Otherwise an unauthorized user could simply unplug the load's power cord from the control and plug it directly into an appropriate wall outlet, thus bypassing the control mechanism. By comparison, the present invention completely replaces an existing detachable power cord. This removes any ability to bypass the control mechanism, thus eliminating the need for any mechanical interlocks.

Prior technology is at further disadvantage for simplicity of installation. Existing designs typically require a dedicated space for mounting, which can be considerable and obtrusive for some products. Aesthetics can also be a concern for some applications. By comparison, the present invention merely replaces the load's existing detachable power cord, so there is no need for any specific mounting.

A final disadvantage of prior art is product cost. The present invention's simple, compact design can easily be manufactured for less cost than any other device providing similar function.

### BRIEF SUMMARY OF THE INVENTION

The primary object of the invention is to incorporate an integral time control into a detachable power cord.

Another object of the invention is to provide a low-cost electrical load timing solution combining simple installation with straightforward, secure operation.

Another object of the invention is to limit the amount of time an electrical load can be used on a given day of the week.

A further object of the invention is to allow programmable usage settings that are secured via keyswitch access.

Yet another object of the invention is to store programmed settings and time-related data in non-volatile memory.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed an apparatus which integrates a time control into a detachable power cord comprising: an integral power input cord having a power input connector capable of being connected directly to a power source, an integral power output cord having a power output connector capable of being connected directly to an electrical load, a switch means for enabling or disabling power to said power output cord, a load status detection means for determining whether said electrical load is ON or OFF, a timekeeping means for tracking time-of-day, a programmable time limit scheme which defines time-based restrictions for usage of said electrical load, a control means which monitors said load status detection means and said timekeeping means, and controls said switch means as defined by said time limit scheme, a non-volatile storage means for retaining data from said timekeeping means and said time limit scheme when input power is removed, a security means for gaining access to, and providing security for, said timekeeping means and said time limit scheme, and a numeric display and a plurality of pushbuttons for system interaction and data entry.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIGS. 1A, 1B, and 1C are schematic block diagrams of different embodiments of the invention.

FIG. 2 is a perspective view of a preferred embodiment of the invention.

FIG. 3 is an abbreviated electrical schematic of a preferred embodiment of the invention which details a DC power supply, load switch, and current sensing circuits.

FIG. 4 is a flow chart of the operations that comprise a preferred embodiment of the invention.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

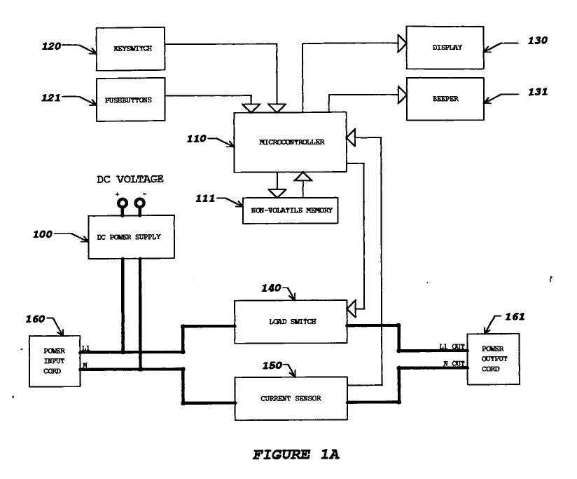

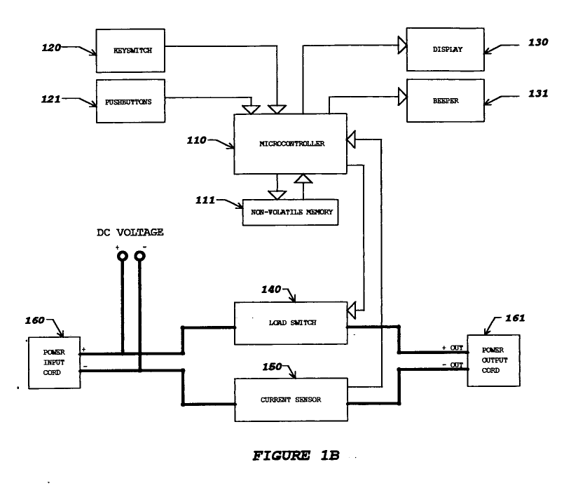

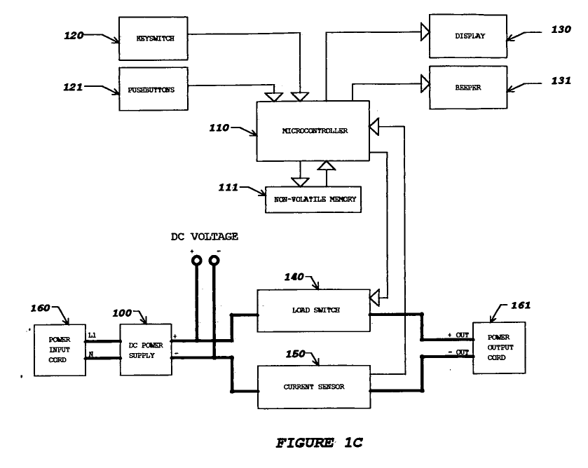

Turning first to FIG. 1A there is shown a schematic block diagram of a preferred embodiment of the invention as applied to AC power applications. The system includes an integral Power Input Cord 160 for direct connection to a power supply, and an integral Power Output Cord 161 for direct connection to an electrical load. These cords have specific power connectors which are identical to those of an existing detachable power cord, thus allowing the invention to completely replace an existing detachable power cord. The system uses DC Power Supply 100 to convert a high AC input voltage (such as 120 Vac) to a low regulated DC voltage (such as 5 Vdc) for use by internal system components. Overall system operation and timekeeping functions are handled by Microcontroller 110, which further uses Non-Volatile Memory 111 (such as an EEPROM) for storage of critical time and program data when input power is removed. It is noted that Microcontroller 110 might already provide non-volatile memory to fulfill this function. Continuing with FIG. 1A, Microcontroller 110 monitors Current Sensor 150 to determine when a load connected to AC Power Output Cord 161 is in use. If the present day's total usage reaches the day's programmed limit, Load Switch 140 will be opened to remove power to AC Power Output Cord 161 and thus turn OFF the connected load. Interface to the system for entering and viewing data is provided through Pushbuttons 121 and Display 130. A Beeper 131 is also provided to warn a user that the day's time limit has nearly been reached, thereby alerting him or her to an impending load switch. System security is provided through Keyswitch 120 which is used to gain access to all system settings.

Turning to FIG. 1B there is shown an embodiment for DC power applications. Here we see that DC Power Supply 100 from FIG. 1A has been eliminated, as incoming power for this application is already DC and directly usable by the system. All other system operation remains as described for FIG. 1A.

Turning to FIG. 1C we see a further embodiment for AC/DC applications where an existing detachable power cord has an AC power input and a DC power output. This is commonly seen where the existing detachable power cord incorporates an AC/DC converter, such as a “wall wart” or similar adapter that converts a high AC voltage to a low, isolated DC voltage. This embodiment is again similar to that shown in FIG. 1A, with the primary difference being the location of DC Power Supply 100 which is now used to supply power to DC Power Output Cord 161 in addition to internal system power. With this embodiment, it is expected that DC Power Supply 100 in FIG. 1C will have significantly more capacity than that of FIG. 1A, and would also have additional isolation requirements.

It is noted that a plurality of Power Output Cords could be provided for any of these embodiments, along with a plurality of Load Switches and Current Sensors, to accommodate multiple power outputs for use by different users and/or different loads.

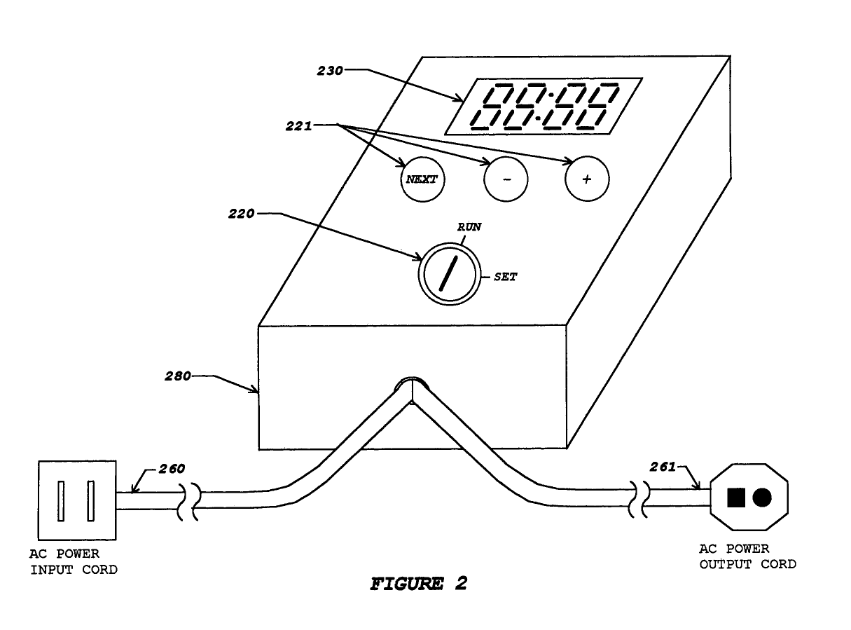

Turning now to FIG. 2 there is shown a perspective view of a preferred embodiment of the invention consistent with the schematic block diagram of FIG. 1A for AC power applications. Here we see integral AC Power Input Cord 260 and integral AC Power Output Cord 261, again having specific power connectors which are identical to those of an existing detachable power cord, thus allowing the invention to completely replace the existing power cord. System control components are housed within Enclosure 280, including Display 230 and Pushbuttons 221. Keyswitch 220, which is switched by a removable key, is moved to the SET position to gain access to all system settings, and moved to the RUN position to provide secure operation.

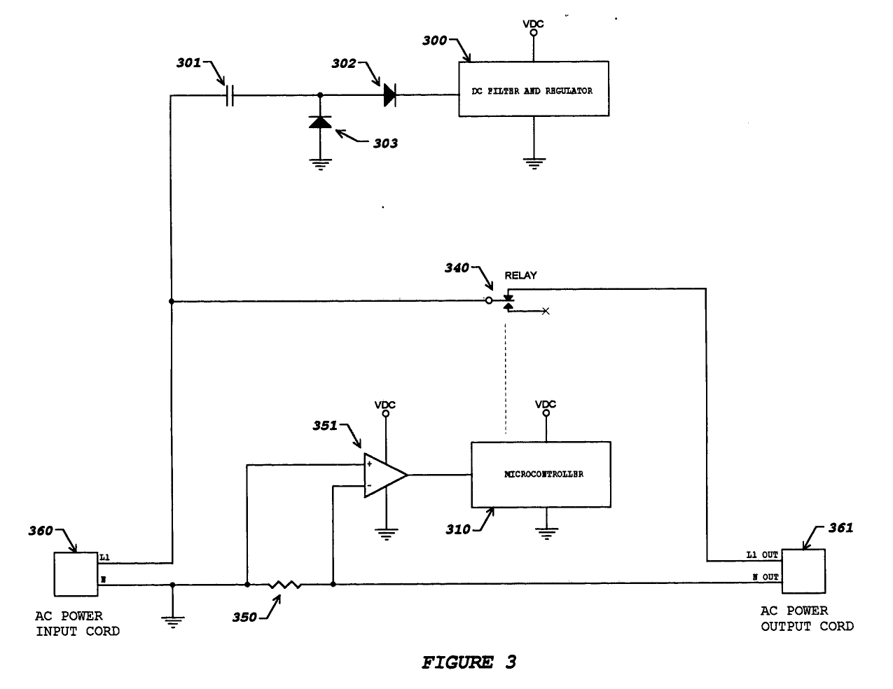

In accordance with an important feature of the invention, there is shown FIG. 3 which highlights a preferred embodiment of power supply, control, and current sensing circuits. Like FIG. 2, this embodiment is also an extension of schematic block diagram FIG. 1A for AC power applications. FIG. 3 illustrates a transformerless DC Power Supply that employs Capacitor 301 as a voltage dropping element, and Rectifier Diodes 302 and 303 for directing current flow from the positive and negative AC power cycles, respectively. This is followed by DC Filter And Regulator 300 for creating a DC Power Supply for use by the system. It is noted that this type of supply, while cost-effective and compact, is not isolated from the incoming AC voltage. To remain safe, such a design must ensure appropriate physical spacing and/or barriers between all system components and the user. Continuing with FIG. 3, Relay 340 provides a simple means of switching power to AC Power Output Cord 361. The system accomplishes load current sensing through Current Sense Resistor 350 and Amplifier 351. Because this embodiment uses a non-isolated DC Power Supply, the current sensing circuitry can also be non-isolated to further reduce size and cost.

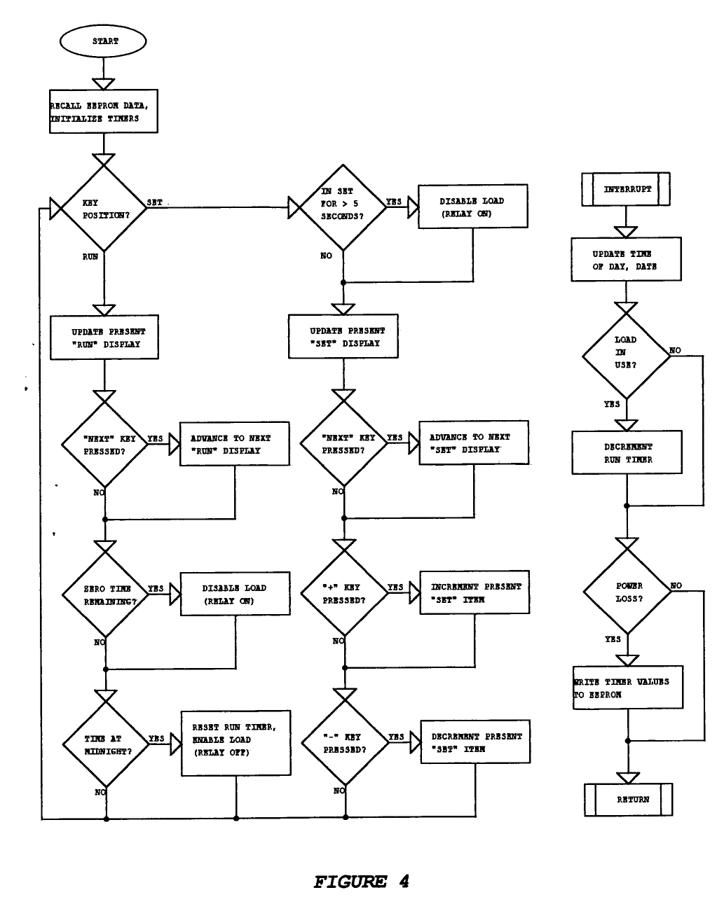

Turning finally to FIG. 4 there is shown a Flowchart which defines system operation for one embodiment of the invention.

The timing and control abilities of the invention are not novel and are well described by prior art. The true essence of the invention is its ability to replace an existing detachable power cord, therein providing an inherent security and simplicity that cannot otherwise be achieved, while simultaneously allowing a low-cost design that can be easily manufactured with standard components. Because the invention integrates specific power input and output connectors, it is a simple exercise to create additional models for any power cord application.

Overall use of the apparatus will first involve installation, which simply involves replacing an existing detachable power cord with the invention. From here, a key is used to move the keyswitch to the SET position, which then allows the user to enter the present day, time of day, and time limits for each day of the week. Upon completion of data entry, the keyswitch is returned to the RUN position and the key removed for security. This action will load a time remaining counter with the day's programmed time allotment. The invention then monitors electrical current flowing to the load connected to the output power cord. When current flow is detected, the device is assumed to be in operation so the time remaining counter is decremented. As the time remaining approaches zero, a warning beeper can sound to alert the user to save any data needed or desired in the future. When time remaining reaches zero, power to the power output cord is switched OFF, thereby disabling the load connected to the power output cord. At midnight, the next day's time allotment is loaded into the time remaining counter and, if necessary, power to the power output cord is switched back ON.

Further operational enhancement could be obtained by introducing a remote control using radio waves, infrared light, or power line communications. In addition to allowing control from a distant location, this would further allow the invention to be programmed through a computer or other device having greater graphics and interface capability. This would allow more sophisticated control programs to be created in a more capable and familiar environment.

Still further enhancement could be achieved by using passwords or other security codes to replace or augment the keyswitch function.

Additional operating modes might include the ability to maintain output power continuously ON, or continuously OFF. In addition, the time-based control might incorporated specific time periods during which output power is disabled.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. An apparatus which integrates a time control into a detachable power cord comprising:
an integral power input cord having a power input connector capable of being connected directly to a power source;
an integral power output cord having a power output connector capable of being connected directly to an electrical load;
a switch means for enabling or disabling power to said power output cord;
a load status detection means for determining whether said electrical load is ON or OFF;
a timekeeping means for tracking time-of-day;
a programmable time limit scheme which defines time-based restrictions for usage of said electrical load;
a control means which monitors said load status detection means and said timekeeping means, and controls said switch means as defined by said time limit scheme;
a non-volatile storage means for retaining data from said timekeeping means and said time limit scheme when input power is removed;
a security means for gaining access to, and providing security for, said timekeeping means and said time limit scheme; and
a numeric display and a plurality of pushbuttons for system interaction and data entry.

2. An apparatus which integrates a time control into a detachable power cord as claimed in claim 1 wherein said power source is an AC voltage and said electrical load requires an AC voltage, and incorporating an integral DC power supply which converts an AC voltage to a low-level, regulated DC voltage for internal system use.

3. An apparatus which integrates a time control into a detachable power cord as claimed in claim 1 wherein said power source is an AC voltage and said electrical load requires a DC voltage, and incorporating an integral DC power supply which converts said AC voltage to a low-level, regulated DC voltage for internal system use and for supplying power to said power output cord

4. An apparatus which integrates a time control into a detachable power cord as claimed in claim 1 wherein said power source is a DC voltage and said electrical load requires a DC voltage.

5. An apparatus which integrates a time control into a detachable power cord as claimed in claim 1 wherein said load status detection means is a current sensor which monitors electrical current in said power output cord.

6. An apparatus which integrates a time control into a detachable power cord as claimed in claim 1 wherein said load status detection means is a switch which enables or disables power to the power output cord, and is connected in series with said switch means.

7. An apparatus which integrates a time control into a detachable power cord as claimed in claim 1 wherein said timekeeping means includes tracking day-of-week (Sunday, Monday, etc.).

8. An apparatus which integrates a time control into a detachable power cord as claimed in claim 1 wherein said time limit scheme assigns a time limit for each day, with said time limit defining maximum ON time of said electrical load.

9. An apparatus which integrates a time control into a detachable power cord as claimed in claim 1 wherein said time limit scheme assigns a time span (such as 7:00 PM to 9:00 PM) for each day, during which said electrical load must be maintained OFF.

10. An apparatus which integrates a time control into a detachable power cord as claimed in claim 1 wherein said non-volatile storage means is an EEPROM or similar memory device.

11. An apparatus which integrates a time control into a detachable power cord as claimed in claim 1 wherein said non-volatile storage means uses a cell, battery, capacitor, or similar energy storage device.

12. An apparatus which integrates a time control into a detachable power cord as claimed in claim 1 wherein said security means is a keyswitch.

13. An apparatus which integrates a time control into a detachable power cord as claimed in claim 1 wherein security means is a password or security code which is entered via said pushbuttons.

14. An apparatus which integrates a time control into a detachable power cord as claimed in claim 1 further comprising a warning means such as a beeper or similar alerting device to warn the user of impending action of said switch means.

15. An apparatus which integrates a time control into a detachable power cord as claimed in claim 1 further comprising a means to allow operation of said electrical load by a plurality of users, whereby each user can be uniquely identified by said control means, and said control means applies said time limit scheme individually to each user.

16. An apparatus which integrates a time control into a detachable power cord as claimed in claim 1 further comprising additional programmable operating modes whereby the power output cord is continuously enabled or continuously disabled.

17. An apparatus which integrates a time control into a detachable power cord as claimed in claim 1 further comprising a remote control means using radio waves, infrared light, power lines, or other such medium.

18. An apparatus which integrates a time control into a detachable power cord as claimed in claim 1 further comprising additional integral power output cords and related means to allow independent timed operation of multiple electrical loads.
